(19) United States
(12) Patent Application Publication
(10) Pub. No.: US 2018/0144360 A1
(43) Pub. Date: May 24, 2018

(54) CASHBACK MANAGEMENT SYSTEM

(71) Applicant: SV INC., Seoul (KR)

(72) Inventors: Yong Hyun Kang, Suwon-si (KR); Du Hyun Kim, Seoul (KR)

(21) Appl. No.: 15/876,089

(22) Filed: Jan. 19, 2018

Related U.S. Application Data
(63) Continuation of application No. PCT/KR2016/007805, filed on Jul. 18, 2016.

(30) Foreign Application Priority Data
Jul. 22, 2015 (KR) 10-2015-0103787

(51) Int. Cl. G06Q 30/02

(52) U.S. Cl. CPC G06Q 30/0226

(57) ABSTRACT

The disclosed technology provides a cashback management system which allows extra accumulation of cashback based on a consumer ranking in a cashback. In one aspect, the cashback management system is provided to comprise: a ranking setting module for setting a consumer ranking in the order of an amount of cashback accumulated in a consumer account and adjusting the ranking according to a change in the amount of the accumulated cashback; and an accumulation module for accumulating a part of cashback generated from a purchase made by a particular consumer to one or more other consumers each with a ranking higher than a ranking of the particular consumer.

### CROSS-REFERENCE TO RELATED APPLICATION(S)

This application claims priority to and the benefit of PCT Application No. PCT/KR2016/007805 filed on Jul. 18, 2016 which claims priority to Korean Patent Application No. 10-2015-0103787 filed on Jul. 22, 2015. The above applications are all hereby incorporated by reference for all purposes as if fully set forth herein.

### TECHNICAL FIELD

Some implementations of the disclosed technology relate to a cashback management system. For example, some implementations of the disclosed technology allow an extra accumulation of cashback.

### BACKGROUND

A cashback is a type of virtual money or cyber money that is awarded to consumers on-line or off-line by companies and the like in order to induce more activities by consumers. The cashback can be used to motivate the consumers to visit a store by allowing the consumer to use of the cashback.

A process for providing cashback generally allows a certain percentage of the purchase price to be accumulated in an account of a consumer who made a corresponding purchase, and allows the consumer to use the accumulated cashback as part of the payment for future purchases or to exchange the accumulated cashback for coupons or specific products.

### SUMMARY

Various implementations are provided to introduce a unique manner of managing cashback which allows consumers to accumulate cashback faster and more effectively. Some implementations of the disclosed technology set a ranking of a consumer according to the amount of cashback accumulated in a consumer account. Therefore, the more the consumer spends, the higher the ranking of the consumer becomes. Some implementations of the disclosed technology allow to accumulate a predetermined ratio of the cashback generated by activities of a particular consumer not only in the account of that particular consumer but also in the accounts of another consumer whose cashback ranking is higher than that particular consumer. Therefore, the higher the ranking of the consumer has, the faster the accumulation of the cashback is made by the activities of other consumers, whereby a cashback management system allows extra accumulation of cashback according to an accumulated cashback ranking. Thus, the consumer can accumulate the cashback more quickly and invest or use the accumulated cashback, which improves the satisfaction of the consumer.

Some implementation of the disclosed technology provides a cashback management system allowing extra accumulation of cashback according to an accumulated cashback ranking. In some implementations, the cashback ranking is determined based on the sum of the amount of money deposited by the consumer and the amount of the cashback generated, whereby the consumer can increase his or her ranking by depositing the money by a suitable method and thus increase the accumulated cashback faster.

In one aspect, a cashback management system is provided to comprise: a ranking setting module for setting a ranking of a consumer based on an amount of cashback accumulated in a consumer account and adjusting the ranking according to a change in the amount of the accumulated cashback; and an accumulation module for accumulating a predetermined ratio of cashback generated by activities, such as consumption or purchase, of the consumer, to one or more other consumers each with a rankings higher than a ranking of the consumer.

In another aspect, a cashback management system based on a consumer ranking associated with an accumulated cashback by a consumer is provided. The cashback management system comprises: a ranking setting module that sets a ranking of a consumer based on an amount of cashback accumulated in a consumer account and adjusts the ranking according to a change in the amount of the accumulated cashback; and an accumulation module that transfers a part of cashback generated from purchases made by a particular consumer to one or more other consumers each with a ranking higher than a ranking of the particular consumer to allow the one or other consumers with a higher ranking to accumulate additional cashback based on ranking, wherein the accumulation module is operable to further: transfer to a first ranked consumer whose ranking is in the first place among ranked consumers, a first additional amount of cashback which is computed from a predetermined ratio of the cashback generated by the particular consumer; and transfer to a second ranked consumer whose ranking is in the second place among ranked consumers, a second additional amount of cashback which is an amount computed from the predetermined ratio of a remaining cashback that is obtained by subtracting the first additional amount of cashback from the cashback generated by the particular consumer, wherein the accumulation module applies the steps sequentially to all of other consumers with rankings higher than that of the particular consumer, and wherein the cashback accumulated in the consumer account further comprises an amount of money deposited by the consumer.

In some implementations, the ranking setting module sets the ranking of the consumer in the order of an amount of the cashback accumulated in the consumer account.

In some implementations, the ranking setting module sets the ranking of the consumer in the order of the sum of the cashback accumulated in the consumer account and purchase money paid from the consumer account.

In some implementations, the purchase money comprises a purchase amount generated by the consumption of the consumer and a prepayment amount.

The disclosed technology provides a cashback management system where the cashback for a particular user can be accumulated based on activities of other users than the particular user as well as activities of the particular user. The cashback accumulated in an account of a particular user comprises the amount of cashback which is generated by the consumption of the particular consumer, and the amount of cashback which is generated by consumption of another consumer. In some implementations, the cashback accumulated in the account of a consumer further comprises the amount of money deposited by the consumer.

According to an embodiment, the ranking setting module adjusts the ranking in real time according to the amount of the accumulated cashback which is changed according to the cashback accumulation by the accumulation module.

According to an embodiment, if a consumer whose ranking is in the Nth place takes an action to create a cashback, the accumulation module accumulates a predetermined ratio of the cashback generated by the consumption of the Nth ranked consumer in accounts of other consumers whose rankings are higher than that of the Nth consumer. Thus, the accumulation module accumulates a portion of the cashback to the first ranked consumer to the (N-1)th ranked consumer, wherein the accumulation module accumulates the predetermined ratio of the generated cashback in the first ranked consumer, and accumulates the predetermined ratio of the cashback which remains after the accumulation for the first ranked consumer to another consumer whose ranking is for example, in the (n-1)th (n is an integer equal to or greater than 2 and equal to or less than N-1). After the accumulation for other consumers, the accumulation module accumulates the remaining cashback for the Nth ranked consumer.

According to an embodiment, the accumulation module deducts a cashback from the consumer account upon a use of the cashback by the consumer.

Some implementations of the disclosed technology provide a cashback management system which determines or sets a ranking of a consumer according to a total amount of cashback accumulated in a consumer account. Therefore, the more the consumer spends, the higher the ranking of the consumer becomes. Since the exemplary cashback management system allows to accumulate a predetermined ratio of the cashback generated by activities of the consumer in another consumer's account in a higher ranking, if the ranking of the consumer is higher, it is possible to accumulate cashback faster by using activities of others who have lower rankings. Accordingly, the cashback management system allows the consumer to accumulate the cashback quickly and use or invest the accumulated cashback, which improves the satisfaction of the consumer.

According to the implementations of the disclosed technology, a mechanism is provided for a consumer to increase his/her ranking since the ranking is decided in consideration of money paid by a consumer (including payments made for not only current purchases but also future activities) and cashback generated by the consumer's activities. Accordingly, the consumer can increase his or her ranking by depositing the money by a suitable method and thus make the accumulation of cashback faster.

### BRIEF DESCRIPTION OF THE DRAWINGS

FIG. 1 is an exemplary view showing a configuration of a cashback management system according to an implementation of the disclosed technology.

FIGS. 2 to 5 are exemplary views showing examples of cashback accumulations and ranking changes in a cashback management system according to an implementation of the disclosed technology.

### DETAILED DESCRIPTION

Techniques disclosed in this patent document provide a cashback management system. The cashback may be referred to as different names, for example, reward points, mileages, coupons, credits, gifts, incentives, etc. The disclosed technology would provide a system and a method for managing those offerings which are given to consumers in connection with activities occurred in an on-line/off-line market or an on-line platform. The disclosed technology allows a consumer to accumulate cashback in a faster and more effective manner to improve consumer experience using cashback.

As cashback marketing can increase the sales revenue and attract customers, there has been an attempt to diversify ways to provide cashback, for example, by setting a high rate of cashback temporarily during an event or providing a certain amount of money as cashback when purchasing a specific product. However, the conventional cashback managements did not make consumers satisfied or attracted to the cashback because it is difficult to accumulate the cashback and thus, there is no investment value in the cashback itself. Accordingly, it is not that uncommon that the amount of the cashback is not even used and disappears.

The examples of the conventional cashback managements are provided: Korean Patent Laid-open Publication No. 10-2013-0062387 (Title: Reserve point management system and method for providing additional reserve point to user selecting affiliation; published on Jun. 13, 2013) and Korean Patent Laid-open Publication No. 10-2012-0048871 (Title of invention: Reserve point management system and method for determining reserve point with regard to transaction between user and advertiser using rate of reserve point determined by advertiser; published on May 16, 2012) are disclosed.

Some implementations of the disclosed technology provide a cashback management system/method which differs from the conventional cashback management systems as discussed below and can solve the problems in the conventional cashback management systems. Hereinafter, various implementations of the disclosed technology will be described in detail with reference to the accompanying drawings so that those skilled in the art can easily carry out the present invention. In the following detailed description of the embodiments of the disclosed technology, a detailed description of known functions or configurations will be omitted. The same reference numerals are used throughout the drawings for portions having similar functions and actions.

In addition, in the entire specification, when a part is referred to as being “connected” with another part, it is not only a case where it is directly connected, but also a case where it is indirectly connected with another element therebetween. Also, “comprising” and “including” mean that other components may be included, rather than excluding other components, unless specifically stated otherwise.

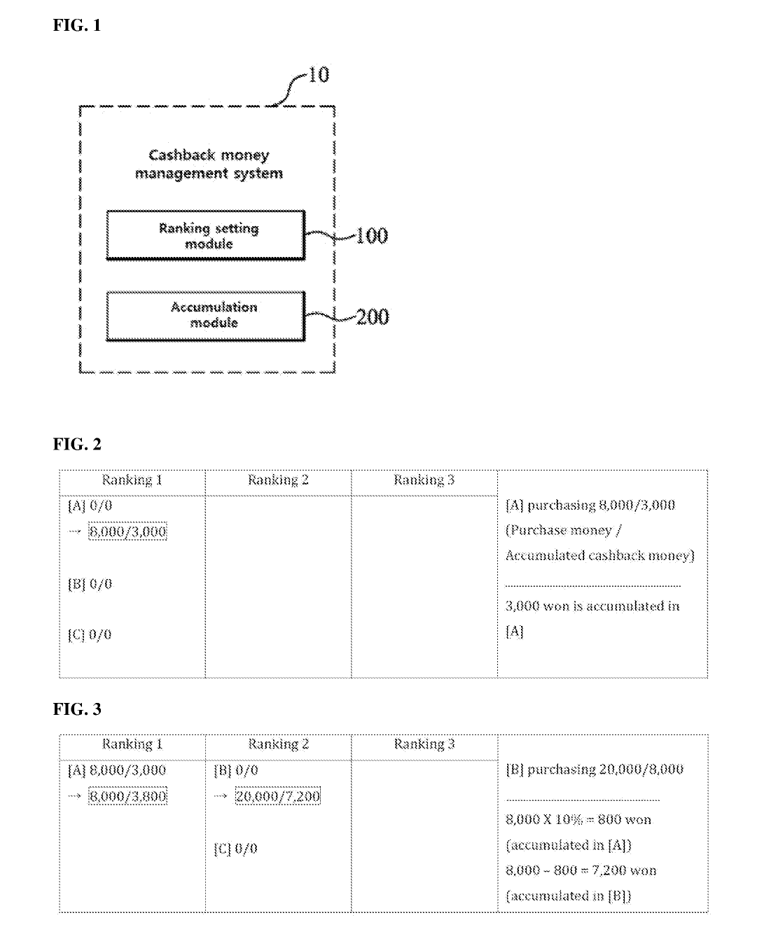

FIG. 1 is an exemplary view showing a configuration of a cashback management system 10 allowing extra accumulation of cashback according to an accumulated cashback ranking, according to an embodiment of the disclosed technology. As shown in FIG. 1, the exemplary cashback management system 10 may comprise a ranking setting module 100 and an accumulation module 200. The term “module” as used herein may include software, hardware, or a combination thereof depending on the context in which the term is used. For example, the software may be machine code, firmware, embedded code, application software, or a combination thereof. Also, for example, the hardware may be a circuit, a processor, a computer, an integrated circuit, integrated circuit cores, or a combination thereof. The ranking setting module 100 and the accumulation module 200 may be implemented in one computer in some applications, or may be distributed in more than one computers or servers linked to a communication network to allow communications between the ranking setting module 100 and the accumulation module 200.

According to some implementations, the ranking setting module 100 may determine or set a ranking of a consumer according to the amount of cashback accumulated in a consumer account associated with the consumer. The accumulation module 200 may accumulate in the consumer account the cashback generated from on-line/off-line activities, for example, purchasing products, by the consumer. Therefore, the more the consumer actively makes purchases or spends money, the higher the ranking of the consumer can be placed at.

As explained above, the cashback is accumulated in the account of the consumer who made purchase or spends money. In some implementations, a predetermined ratio of the cashback generated from on-line/off-line activities of the consumer is accumulated in not only the account of the consumer but also the account of another consumer whose ranking is placed at higher than that of the consumer. Thus, consumers whose rankings are relatively higher can get “extra” accumulation of the cashback from the activities of others whose rankings are relative lower. Therefore, if the consumer's raking is higher, the consumer can accumulate the cashback faster since the cashback can be accumulated from the activities of other consumers who are placed in a lower ranking. Thus, the consumer can accumulate the cashback quickly and invest the accumulated cashback as desired.

Hereinafter, each element of the cashback management system 10 allowing extra accumulation of the cashback according to the accumulated cashback ranking, according to an implementation of the disclosed technology will be described in detail.

The ranking setting module 100 may be structured to determine or set a ranking of a consumer based on cashback accumulated in the consumer account and/or activities of the consumer. In some implementations, the ranking setting module 100 may determine or set the ranking of the consumer according to the amount of the cashback accumulated in the consumer account and adjust the ranking according to change in the amount of the accumulated cashback. The ranking setting module 100 may determine or set the ranking of the consumer in the order of the amount of the cashback accumulated in the consumer account.

The cashback accumulated in the consumer account may comprise the amount of the cashback which is generated by activities of the consumer, and the amount of the cashback which is generated by activities of other consumers. The activities of the consumer to generate the cashback include making payments such as purchasing of a product. The cashback accumulated in the consumer account may further comprise the amount of the money deposited by the consumer. Thus, the consumer can add his or her money to the accumulated cashback by making deposits, for example, using credit cards, bank transfer, gift cards, points, coupons, etc. The money deposited in this way may be added to the cashback which have been earned from the activities by the consumer and managed as the accumulated cashback in the account of the consumer. Therefore, the consumer who wants to increase the ranking quickly can increase the ranking by depositing the money in the consumer account and increasing the amount of the accumulated cashback by the deposited money.

In some implementations, the ranking of the consumer may be determined or set based on both the cashback accumulated in the consumer account and the activities of the consumer. For example, the ranking setting module 100 determines or sets the ranking in the order of the sum of the cashback accumulated in the consumer account and the purchase money paid from the consumer account. In this case, the degree of contribution of the consumer to the purchase money by activities, for example, purchases, can be reflected in the ranking. The degree of contribution may be different in various products depending on the types of the products. For example, there may be a product with a relatively small accumulation amount relative to the price of the product and there may be another product with a relatively big accumulation amount relative to the price of the product. The disclosed technology can provide the cashback money management system to minimize or avoid the feeling that the consumer is disadvantaged through the purchase of a product, and allow the consumer to be ranked more fairly.

In some implementations, the purchase money may comprise a purchase amount generated by activities of the consumer and a prepayment amount. The consumer may make a payment in advance for the amount to be used without purchasing the product, and by including this prepayment amount in the purchase money, the actual amount spent by the consumer can be accurately reflected in the ranking. Furthermore, the purchase money may be considered only for a predetermined period of time, such as 6 months, 1 year, 3 years, etc., which can lead the consumer to continue to create activities by, for example, spending money and provide a way for new consumers to be placed at a high ranking.

The ranking setting module 100 may adjust the ranking in real time according to the amount of the accumulated cashback which are changed according to the cashback accumulation of the accumulation module 200, which will be described in detail below. The amount of the accumulated cashback of each consumer may be changed according to the accumulation result of the accumulation module 200, and the ranking setting module 100 may reflect the change in the amount of the accumulated cashback in the ranking in real time.

The accumulation module 200 may accumulate a predetermined ratio of the cashback generated by activities of the consumer to a higher ranked consumer. When the cashback is generated by activities of the consumer having a specific ranking set by the ranking setting module 100, a part of the generated cashback may be accumulated as well in the account of a consumer having a ranking higher than the specific ranking. Therefore, the consumer with a higher ranking can automatically increase the accumulated cashback due to the activities of others, even if he/she is not involved with any activities.

In some implementations, the accumulation module 200 may accumulate a predetermined ratio of the cashback generated by activities of a Nth ranked consumer in the accounts of consumers who have ranked the first to (N-1)th. In accumulating a predetermined ratio of the cashback generated by a Nth ranked consumer, the accumulation module 200 may be structured to provide the cashback to all of the consumers who have ranked the first to (N-1)th. In some implementations, the accumulation module 200 may be structured to provide the cashback to only a part of the consumers among those who have ranked the first to (N-1)th. Thus, the accumulation module 200 may first select all or a part of the consumers who have ranked the first to (N-1)th. In some implementations, the accumulation module 200 may accumulate, in the accounts of the selected consumers among those in the first to (N-1)th places, different amounts of the generated cashback. For example, the accumulation module 200 may accumulate the predetermined ratio of the generated cashback in the first ranked consumer. Then, the accumulation module 200 may accumulate the predetermined ratio of the remaining cashback which remains after the accumulation for the first ranked consumer in the account of the second ranked consumer. The accumulation module 200 may repeat the accumulation in this manner for the remaining selected consumers. After making accumulations in the accounts of the selected consumers among those in the first to (N-1)th places, the accumulation module 200 may accumulate the remaining cashback in the account of the Nth ranked consumer.

For example, if cashback is generated by activities of the 10th ranked consumer, a predetermined ratio of the cashback is sequentially provided to the first ranked consumer to the 9th ranked consumer, and the remaining cashback is accumulated in the 10th ranked consumer. Among the higher ranked consumers, the cashback provided to the first consumer is the greatest, the amount of the provided cashback is gradually reduced, and the cashback provided to the 9th ranked consumer is the smallest. The cashback generated from the activities of the 10th ranked consumer is not provided to the 11th ranked consumer and the consumers having rankings lower than the 11th.

The ranking setting module 100 may adjust the ranking in real time by reflecting the accumulation result of the accumulation module 200 as described above. Therefore, the ranking may be changed each time at the generation and accumulation of the cashback.

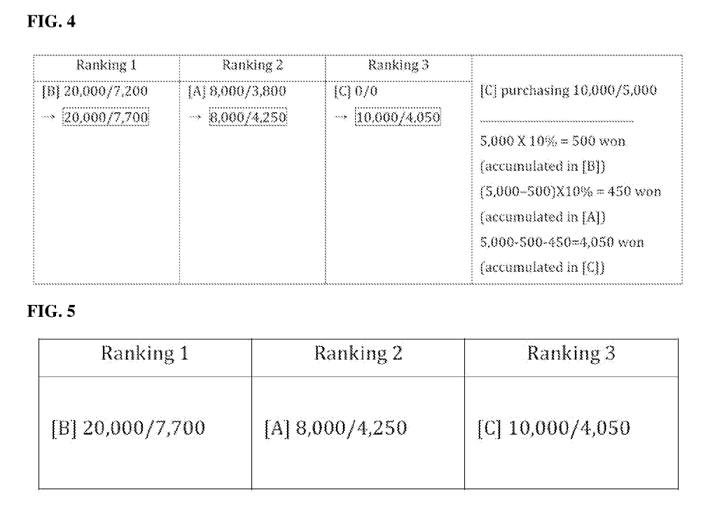

FIGS. 2 to 5 are exemplary views showing examples of cashback accumulations and ranking changes in the cashback management system 10 allowing extra accumulation of cashback according to the accumulated cashback ranking. Hereinafter, with reference to FIGS. 2 to 5, a description of a ranking setting process and a cashback accumulation process of the cashback management system 10 will be given in detail.

First, as shown in FIG. 2, if the purchase money and the accumulated cashback of the consumers A, B, and C are all 0 (zero), the rankings of the consumers A, B, and C are the same. In this situation, if the consumer A purchases a product which is priced with a price of 8,000 Korean won (KRW) and is listed as providing a cashback of 3,000 Korean won in response to the purchase, the cashback of 3,000 Korean won are all accumulated in the consumer A since there is no higher ranked consumer than the consumer A.

After the accumulation result is reflected, the ranking setting module 100 sets the consumer A (accumulated cashback of 3,000 Korean won) as the first place and the consumers B and C (accumulated cashback of 0 Korean won) as the second place, and adjusts the ranking as shown in FIG. 3. If the second ranked consumer B purchases a product with a price of 20,000 Korean won and the purchase of the product provides a cashback of 8,000 Korean won, a part of the cashback of 8,000 Korean won is accumulated to the higher ranked consumer A than the consumer B as well as the second ranked consumer B. For example, if the predetermined ratio is 10%, the amount of 800 Korean won, which is 10% of the cashback of 8,000 Korean won, is added to the account of the higher ranked consumer A than the consumer B, and the amount of the accumulated cashback of the consumer A becomes 3,800 Korean won, and the remaining cashback of 7,200 Korean won is accumulated to the account of the consumer B.

As a result, since the amount of the accumulated cashback of the consumer B becomes greater than that of the consumer A, the ranking setting module 100 sets the ranking of the consumer B (accumulated cashback of 7,200 Korean won) as the first, the ranking of the consumer A (accumulated cashback of 3,800 Korean won) as the second, and the ranking of the consumer C (accumulated cashback of 0 Korean won) as the third. If the third ranked consumer C purchases a product with a price of 10,000 Korean won and the purchase provides a cashback of 5,000 Korean won, the amount of 500 Korean won, which is 10% of the cashback of 5,000 Korean won, is first added to the account of the first ranked consumer B between the higher ranked consumers A and B than the consumer C, and the amount of the accumulated cashback of the consumer B becomes 7,700 Korean won. The amount of 450 Korean won, which is 10% of the remaining cashback of 4,500 Korean won, is added to the account of the second ranked consumer A, and the amount of the accumulated cashback of the consumer A becomes 4,250 Korean won. After the cashback accumulation for the consumers A and B, the remaining cashback of 4,050 Korean won is accumulated to the account of the consumer C.

If the ranking setting module 100 determines the ranking based on the amount of the accumulated cashback only, the consumer B will be ranked first, the consumer A will be ranked second, and the consumer C will be ranked third, as shown in FIG. 5. If the ranking setting module 100 determines the ranking based on the sum of the purchase money and the accumulated cashback, the consumer B will be ranked first, the consumer C will be ranked second, and the consumer A will be ranked third. In the latter case, the activity by the consumer C can change the rankings of the consumers A and C.

If the consumer uses the accumulated cashback, the accumulation module 200 deducts the used cashback from the consumer account. Thus, the accumulated cashback can be used as cash when purchasing a product. If the consumer makes a settlement using the accumulated cashback, the accumulation module 200 deducts the accumulated cashback as much as the used amount. Since the amount of the accumulated cashback of the consumer is reduced, the ranking setting module 100 adjusts the ranking in real time reflecting the subtracted accumulated cashback.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve described results. Moreover, the separation of various system components in the embodiments described in this patent document should not be understood as requiring such separation in all embodiments. Only a few implementations and examples are described. Other implementations, enhancements and variations can be made based on what is described and illustrated in this patent document.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A cashback management system allowing extra accumulation of cashback based on a cashback ranking, the cashback management system comprising:
a ranking setting module that sets a ranking of a consumer in the order of an amount of cashback accumulated in a consumer account and adjusts the ranking according to a change in the amount of the accumulated cashback; and
an accumulation module that accumulates a part of cashback generated from a purchase made by a particular consumer to one or more other consumers each with a ranking higher than a ranking of the particular consumer,
wherein the accumulation module is operable to accumulate the part of the cashback money to one or more other consumers each with a ranking higher than the ranking of the particular consumer by steps including:
accumulating to a first ranked consumer whose ranking is in the first place a first amount that is a predetermined ratio of the cashback generated by the purchase of the particular consumer; and
accumulating to a second ranked consumer whose ranking is in the second place a second amount that is the predetermined ratio of an amount that is obtained by subtracting the first amount from the cashback generated by the purchase of the particular consumer,
wherein the accumulation module applies the steps sequentially to all of other consumers with rankings higher than the ranking of the particular consumer and accumulates to the particular consumer a remaining amount of the cashback after the cashback is allocated to all of other consumers with rankings higher than the ranking of the particular consumer, and
wherein the cashback accumulated in the consumer account further comprises an amount of money deposited by the consumer.

2. The cashback money management system according to claim 1,
wherein the ranking setting module sets the ranking of the consumer in the order of a sum of the cashback accumulated in the consumer account and purchase money paid from the consumer account.

3. The cashback money management system according to claim 2,
wherein the purchase money comprises a purchase amount generated by purchase of the consumer and a prepayment amount.

4. The cashback money management system according to claim 1,
wherein the ranking setting module adjusts the ranking in real time according to the amount of the accumulated cashback which is changed according to the accumulation of the cashback by the accumulation module.

5. The cashback money management system according to claim 1,
wherein the accumulation module deducts a cashback from the consumer account upon an use of the cashback by the consumer.
